(19) United States
(12) Patent Application Publication
(10) Pub. No.: US 2014/0062356 A1
(43) Pub. Date: Mar. 6, 2014

(54) INVERTER FOR DRIVING AN ELECTRICAL LOAD AND METHOD FOR OPERATING AN INTERTER

(71) Applicant: Robert Bosch GmbH, Stuttgart (DE)

(72) Inventors: Christian Djonga, Heilbronn (DE); Andrea Deflorio, Marbach Am Neckar (DE); Daniel Zimmermann, Nienburg (DE)

(21) Appl. No.: 14/011,881

(22) Filed: Aug. 28, 2013

(30) Foreign Application Priority Data
Sep. 6, 2012 (DE) 10 2012 215 811.1

(51) Int. Cl. H02M 7/44; H02P 6/00

(52) U.S. Cl. CPC H02M 7/44; H02P 6/001
USPC 318/400.04; 363/55

(57) ABSTRACT

A method for operating an inverter, wherein the inverter can be connected to a DC voltage source on the input side for the purpose of electrical energy supply, wherein the inverter has a plurality of controllable switches which are switched alternately in order to provide a polyphase electric current on a corresponding plurality of phase lines of the inverter, in particular in order to supply an electric machine with electric current in polyphase fashion, wherein at least one electrical variable of at least one of the phase lines and at least one switch-on time of at least one of the controllable switches are detected and an input current is determined on the basis of the detected variables.

### BACKGROUND OF THE INVENTION

The present invention relates to a method for operating an inverter, wherein the inverter can be connected to a DC voltage source on the input side for the purpose of electrical energy supply, wherein the inverter has a plurality of controllable switches which are switched alternately in order to provide a polyphase electric current on a corresponding plurality of phase lines of the inverter, in particular in order to supply an electric machine with electric current in polyphase fashion.

The present invention furthermore relates to an inverter for driving an electrical load, in particular an electric machine, wherein the inverter has input terminals which can be connected to a DC voltage source for the purpose of the electrical energy supply of the inverter, wherein the inverter has a plurality of controllable switches which can be driven alternately by means of a control unit in order to provide a polyphase electric current on a corresponding plurality of phase lines of the inverter, in particular in order to supply the electric machine with electric current in polyphase fashion.

Finally, the present invention relates to a motor vehicle drivetrain having at least one electric machine for providing drive power and an inverter for driving the electric machine of the type described above.

In the technical field of three-phase loads in general and three-phase electric machines specifically, it is generally known to use inverters in order to convert a DC current provided by a DC voltage wave into a polyphase AC current in order to energize the electrical load in polyphase fashion. In this case, the input current of the inverter is usually measured by means of an ammeter in order to be able to limit the current drawn from the DC voltage source and to safeguard the overall system.

An ammeter for measuring the input current is subject to a certain inertia particularly at the high switching speeds of the inverter, has tolerances and constitutes an additional component that increases the costs for producing the inverter.

Consequently, in the known inverters with an ammeter for measuring the input current, it is disadvantageous that the measured input current is inaccurate at high switching frequencies and that the additional ammeter increases the costs of the inverter.

### SUMMARY OF THE INVENTION

The invention therefore provides a method for operating an inverter of the type mentioned in the introduction, wherein at least one electrical variable of at least one of the phase lines and at least one switch-on time of at least one of the controllable switches are detected and an input current of the inverter is determined on the basis of the detected variables.

Furthermore, the invention therefore provides an inverter for driving an electrical load of the type mentioned in the introduction, wherein detection means are assigned to at least one of the phase lines in order to detect at least one electrical parameter of the phase line, and wherein the control unit has means for detecting at least one switch-on time of at least one of the controllable switches, and wherein the inverter furthermore has determining means designed for determining an input current in the input terminals on the basis of the detected variables.

Finally, the invention provides a motor vehicle drivetrain having at least one electric machine for providing drive line and an inverter for driving the electric machine of the type described above.

By virtue of the fact that the input current is determined on the basis of at least one electrical variable of at least one of the phase lines and a switch-on time of at least one of the controllable switches, it is possible to dispense with the additional ammeter at the input of the inverter. Since the controllable switches are subject to very low inertia and have low tolerances and the calculated input current is determined only depending on the switch-on time of the switches and at least one electrical variable of the phase lines, the input current can be determined precisely. As a result, the input current can thus be determined with lower outlay and higher precision.

Preferably, the electrical variable is an electric current in the corresponding phase line.

As a result, the phase current of each of the phase lines can be determined with low technical outlay.

It is furthermore preferred if each of the phase lines is respectively assigned at least one of the controllable switches, and wherein the switch-on time of a plurality of the controllable switches which are assigned to different phase lines is detected.

As a result, the precision with which the input current is determined can be increased further.

In this case, it is particularly preferred if the controllable switches whose switch-on time is detected are assigned to a high voltage potential of the DC voltage source if a phase current is positive, and are assigned to a low voltage potential of the DC voltage source if the phase current is negative.

As a result, the calculation of the input current becomes simpler and the computational complexity for determining the input current becomes lower.

It is furthermore preferred if the inverter has a first plurality of phase lines and wherein a second plurality of phase lines are respectively assigned detection means for detecting the electrical variable.

As a result, the technical outlay for detecting the electrical parameter can be reduced.

It is particularly preferred here if one of the phase lines has no detection means.

As a result, the technical outlay for detecting the phase currents can be reduced and the precision can simultaneously be maintained since the phase currents are dependent on one another and can be calculated correspondingly.

It is furthermore preferred if the electric current in the phase line is determined for the switch-on time of the corresponding switch and the electric current in the phase line is determined separately for the switch-off time.

As a result, the precision with which the input current is determined can be increased further since both the current for the switch-off phase and the current for the switch-on phase of the controllable switch are determined.

In this case, preferably only the switching instant of the controllable switch is detected and the electric current is detected at specific instants and the electric current for the entire switch-on phase and the entire switch-off phase is determined on the basis of the measured values.

It is furthermore preferred if the electrical variable on the basis of an electrical charge which flows through the controllable switches and freewheeling diodes which are assigned to the high voltage potential of the DC voltage source, or on the basis of an electrical charge which flows through the controllable switches and freewheeling diodes which are assigned to the low voltage potential of the DC voltage source, or on the basis of a combination of the two quantities of electrical charge thus calculated.

As a result, the electrical variable can be determined more rapidly and more precisely.

It is furthermore preferred if the input current is not determined if all controllable switches which are assigned to the high voltage potential or to the low voltage potential of the DC voltage source are closed.

As a result, the technical computational complexity of the method can be reduced since the input current is equal to zero in this case.

It is furthermore preferred if the electrical variable and the switch-on time are integrated over a predefined time interval. As a result, the electric current can be determined with low technical outlay.

It is furthermore preferred if the switch-on time and the electrical parameter are detected over a pulse width modulation period of the inverter.

As a result, the phase currents can be integrated over a pulse width modulation period and the input current can be calculated precisely.

It goes without saying that features, properties and advantages of the method according to the invention also correspondingly apply or are applicable to the device according to the invention.

### BRIEF DESCRIPTION OF THE DRAWINGS

FIG. 1 schematically shows an inverter for driving an electrical load;

FIG. 2 schematically shows the profile of a phase current during the switch-on time of the corresponding phase; and

FIG. 3 schematically shows a flowchart for elucidating the method according to the invention.

### DETAILED DESCRIPTION

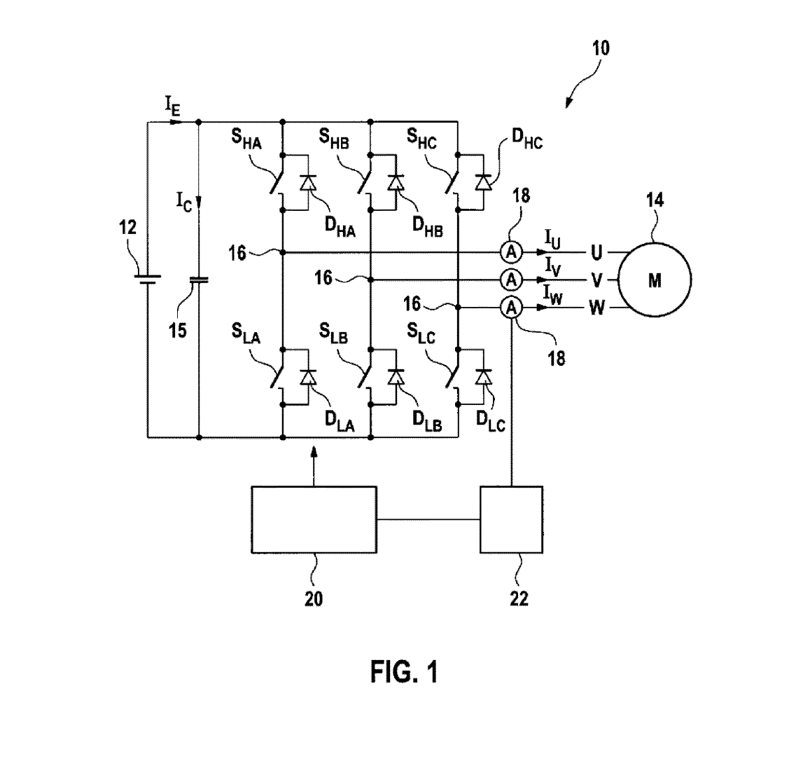

In FIG. 1, an inverter for driving an electrical load, in particular an electric machine, is illustrated schematically and designated generally by 10.

The inverter 10 is connected to a DC voltage source 12 by means of input terminal lines and serves for energizing the electrical load 14, which is embodied as an electric machine 14 in this case, in three-phase fashion. The inverter 10 has three half-bridges which are connected in parallel with the DC voltage source 12 and each have two controllable switches S. A half-bridge tap 16 is in each case formed between the switches S, these half-bridge taps in each case being connected to a phase conductor of the phases U, V, W of the electric machine 14. The inverter 10 has an intermediate circuit capacitor 15 connected in parallel with the DC voltage source 12. A respective ammeter 18 is assigned to the phase conductors U, V, W in order to measure the respective phase current IU, IV, IW. A respective freewheeling diode D is connected in parallel with the switches S and enables current to flow in the opposite direction.

In FIG. 1, the switches S are designated by SHA, SLA, SHB, SLB, SHC, SLC according to the phase U, V, W which they provide and according to the assignment to a high potential of the DC voltage source 12 or a low potential of the DC voltage source 12. The freewheeling diodes are correspondingly designated by DHA, DLA, DHB, DLB, DHC, DLC.

As a result of the switches S being alternately opened and closed, a respective drive voltage is applied between the phase conductors U, V, W, such that a respective phase current IU, IV, IW is correspondingly established, which drives the electric machine 14. Depending on the phase current IU, IV, IW provided and depending on the driving of the controllable switches S, an input current I_{E} is established in the input lines. An intermediate circuit current Ic flows into the intermediate circuit capacitor 15. The inverter 10 is preferably embodied by means of semiconductor switches. The switches of the inverter 10 are alternately opened and closed by means of a schematically illustrated control unit 20 in order to provide the phase voltages with a specific profile and to energize the electric machine 14 correspondingly with the phase currents IU, IV, IW.

The inverter 10 furthermore has a computing unit, which is illustrated schematically in FIG. 1 and is generally designated by 22. The computing unit 22 is connected to the control unit 20 and to the ammeters 18 in order to determine the input current I_{E} on the basis of the measured phase currents IU, IV, IW and switch-on times t of the controllable switches S, as will be explained in greater detail below.

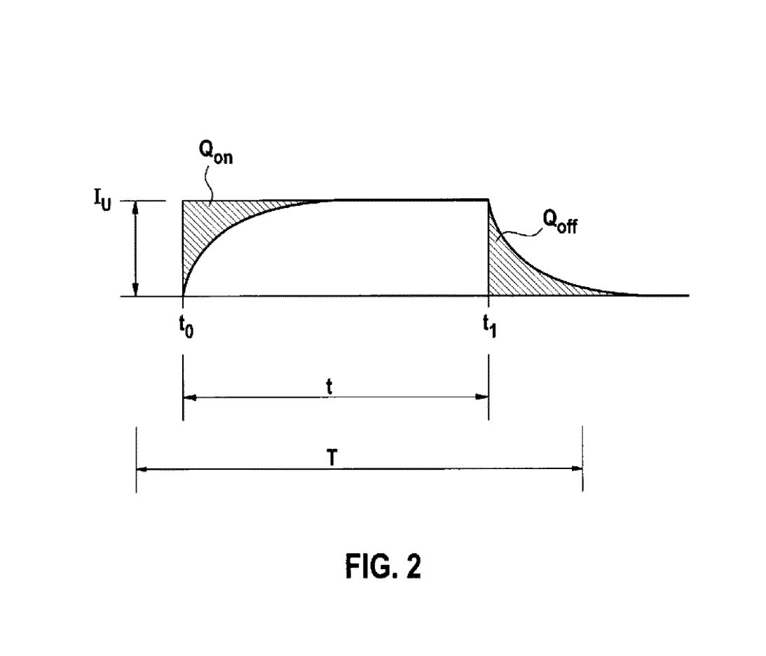

FIG. 2 schematically illustrates the profile of the phase current IU during the switch-on time t. FIG. 2 relates to a predefined time interval T, which corresponds to the pulse width modulation period in one particular embodiment. In the time interval T, the electric current in the components SHA, DHA of the upper side of the half-bridge of the phase U rises if the assigned controllable switch SHA is closed, and reaches the maximum value and correspondingly falls again starting from the instant t1 if the assigned controllable switch is opened. A quantity of charge Q_{U} which flows in the components SHA, DHA of the half-bridge of the corresponding phase line corresponds to the area beneath the current curve (see FIG. 2). In order to simplify the integral, the switches S are initially assumed to be ideal. As a result, in FIG. 2, for example, the corresponding area becomes a rectangle. The influence of the switch-on and switch-off effects of the current is taken into account by the hatched area Q_{ON} and Q_{OFF}. In this case, the area Q_{ON} has to be subtracted from the total charge calculated for an ideal switch, and the hatched area Q_{OFF} has to be added to the total charge calculated for an ideal switch. The areas Q_{ON} and Q_{OFF} can be determined as a product of the current IU at the switch-on instant and a constant and the charge Q_{OFF} can be calculated as a product of the current IU at the switch-off instant of the corresponding controllable switch and a constant. In general, therefore, the charge Q_{U} in the phase conductor U can be calculated on the basis of the formula

$${Q}_{U} = {\int }_{r}^{ } {i}_{U} = \text{?} {i}_{U} d t - {k}_{ON\_P} {\sum }_{ }^{ } {i}_{ON\_P} + \text{?} {\sum }^{ } \text{?} - {k}_{ON\_P} \sum \text{?}$$

$$\text{?} \text{indicates text missing or illegible when filed}$$

wherein the integral of i_{U} relates to the current which flows in the components SHA, DHA of the half-bridge of the phase U with ideal switches S having an infinitely short switching time. In the formula mentioned above, k_{ON}_{_{—}}_{P} is a constant, i_{ON}_{_{—}}_{P} is the phase current if the upper controllable switch of the assigned half-bridge is closed and the flowing current is positive, k_{OFF}_{_{—}}_{N} is a constant, and i_{OFF}_{_{—}}_{N} is the phase current if the upper switch of the assigned half-bridge is opened and the current is negative, k_{ON}_{_{—}}_{N} is a constant and i_{ON}_{_{—}}_{N} is the phase current if the upper switch of the assigned half-bridge is closed and the phase current is negative, k_{OFF}_{_{—}}_{P} is a constant and i_{OFF}_{_{—}}_{P} is the phase current if the upper switch of the assigned half-bridge is opened and the current is positive. In a simplified calculation variant, the constants k can also be disregarded and assumed to be zero. The time period in which the charge which flows in the corresponding phase conductor, here the phase conductor U, is calculated as the time period in which the upper switch of the corresponding phase is closed and opened if the phase current IU is positive. The time period over which the flowing charge Q_{U} is determined is calculated as the time period in which the lower switch of the corresponding phase U is closed and opened if the corresponding phase current is negative.

The flowing charges Q_{V} and Q_{W} for the phases V, W are also calculated correspondingly.

The flowing charges Q_{U}, Q_{V}, Q_{W} and a charge Q_{C} which flows into the intermediate circuit capacitor 15 are added to form a total charge Q and the input current I_{E} is calculated on the basis of the time interval T taken into account.

The time interval can be e.g. a pulse width modulation period T of the inverter 10.

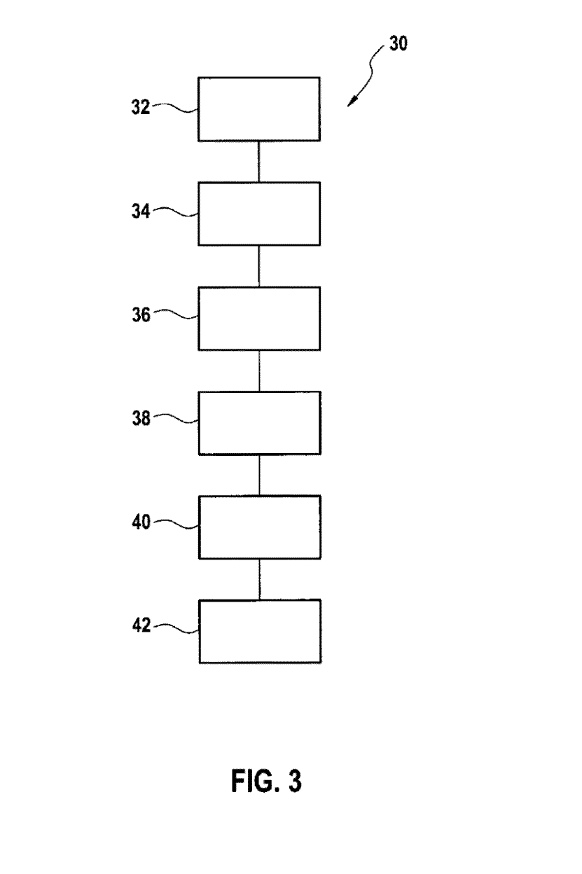

In FIG. 3, a method for determining the input current I_{E} is illustrated schematically as a flowchart and designated generally by 30.

At 32, the current IU, IV, IW of the corresponding phase U, V, W during the switch-on time t is measured. Furthermore, at 34, the phase current IU, IV, IW during the switch-off time of the corresponding switch S is calculated or measured. The quantities of charge Q_{ON} and Q_{OFF} are determined on the basis of the measured currents at 36. At 38, the total charge Q_{U}, Q_{V}, Q_{W} for the corresponding phase conductor U, V, W is determined from the phase current IU, IV, IW and the charges Q_{ON}, Q_{OFF}. At 40, the charges Q_{U}, Q_{V}, Q_{W} and the charge Q_{C} of the intermediate circuit capacitor 15 are added. In this case, Q_{C} is usually assumed to be zero in order to determine Q_{DC} as the total charge. At 42, the input current I_{E} is then determined by dividing the total charge Q_{DC} by the measured time period. The measured time period can be e.g. the pulse width modulation period T of the inverter 10.

As a result, it is thus possible to determine the input current I_{E} on the basis of the switching times of the inverter 10 and the phase currents of the phases U, V, W using simple means and precisely. Since the average value of the current I_{DC} in the intermediate circuit capacitor 15 is usually very low or zero, Q_{C} can also be disregarded in the calculation.

Since the sum of all the phase currents is zero, the measurement of one of the phases can be dispensed with.

1. A method for operating an inverter, wherein the inverter can be connected to a DC voltage source on the input side for the purpose of electrical energy supply, wherein the inverter has a plurality of controllable switches which are switched alternately in order to provide a polyphase electric current on a corresponding plurality of phase lines of the inverter), wherein at least one electrical variable of at least one of the phase lines and at least one switch-on time of at least one of the controllable switches are detected and an input current of the inverter is determined on the basis of the detected variables.

2. The method according to claim 1, wherein the electrical variable is an electric current in the corresponding phase line.

3. The method according to claim 1, wherein each of the phase lines is respectively assigned at least one of the controllable switches, and wherein the switch-on time of a plurality of the controllable switches which are assigned to different phase lines is detected.

4. The method according to claim 3, wherein the controllable switches whose switch-on time is detected are assigned to a high voltage potential of the DC voltage source if a phase current is positive, and are assigned to a low voltage potential of the DC voltage source if the phase current is negative.

5. The method according to claim 1, wherein the inverter has a first plurality of phase lines and wherein a second plurality of phase lines are respectively assigned detection means for detecting the electrical variable.

6. The method according to claim 5, wherein one of the phase lines has no detection means.

7. The method according to claim 2, wherein the electric current in the phase line is determined for the switch-on time of the corresponding switch and the electric current in the phase line is determined separately for the switch-off time.

8. The method according to claim 2, wherein the electrical variable is determined on the basis of an electrical charge which flows through the controllable switches and freewheeling diodes which are assigned to the high voltage potential of the DC voltage source, or on the basis of an electrical charge which flows through the controllable switches and freewheeling diodes which are assigned to the low voltage potential of the DC voltage source, or on the basis of a combination of the two quantities of electrical charge thus calculated.

9. The method according to claim 2, wherein the input current is not determined if all controllable switches which are assigned to a high voltage potential or to a low voltage potential of the DC voltage source are closed.

10. The method according to claim 1, wherein the switch-on time and the electrical parameter are detected over a predefined time.

11. The method according to claim 10, wherein the switch-on time and the electrical parameter are detected over a pulse width modulation period of the inverter.

12. An inverter for driving an electrical load, wherein the inverter has input terminals which can be connected to a DC voltage source for the purpose of the electrical energy supply of the inverter, wherein the inverter has a plurality of controllable switches which can be driven alternately by means of a control unit in order to provide a polyphase electric current on a corresponding plurality of phase lines of the inverter (10), in particular in order to supply an electric machine with electric current in polyphase fashion, wherein detection means are assigned to at least one of the phase lines in order to detect at least one electrical parameter of the phase line , and wherein the control unit has means for detecting at least one switch-on time of at least one of the controllable switches, and wherein the inverter furthermore has determining means designed for determining an input current in the input terminals on the basis of the detected variables.

13. A motor vehicle drivetrain having at least one electric machine for providing drive power and an inverter for driving the electric machine according to claim 12.
